(19) United States
(12) Patent Application Publication
(10) Pub. No.: US 2011/0209384 A1
(43) Pub. Date: Sep. 1, 2011

(54) INSECT TRAP

(76) Inventor: Kim Zoëga Møller, Viby J (DK)

(21) Appl. No.: 13/122,178

(22) PCT Filed: Oct. 1, 2009
(86) PCT No.: PCT/DK2009/050256

§ 371 Date: May 20, 2011

(30) Foreign Application Priority Data
Oct. 1, 2008 (DK) PA 2008 01376

(51) Int. Cl. A01M 1/10

(52) U.S. Cl. 43/107

(57) ABSTRACT

An insect trap top 1 for mounting on a container 10 with a protrusion. The insect trap top 1 comprises at least one entrapment element 5 for entrapping an insect, at least one fastening element 2 for connecting the insect trap top 1 with the container 10. The at least one fastening element 2 comprises a flexible part with at least one securing member 6 such that when pressed on the container 10 the at least one securing member 6 and the protrusion 12 snap lock. Further an entrapment system 15 for entrapment of insects, comprising a container 10 with at least one protrusion 12 and an insect trap top 1 is disclosed.

The present invention relates to an insect trap top in particular an insect trap top for mounting on a container with a protrusion. The insect trap top comprises at least one entrapment element for entrapping an insect, at least one fastening element for connecting the insect trap top to the container, wherein the at least one fastening element comprises a flexible part with at least one securing member such that when pressed onto the protrusion of the container the flexible part give way and the at least one securing member and the protrusion snap lock. The invention further relates to an entrapment system for entrapment of insects with an insect trap top.

Such an insect trap top and entrapment system are known from GB 365,231. The insect trap top presented therein discloses a securing member in form of four round corners bent round under a plate. This is a drawback as it requires at least two manufacturing steps to produce such an insect trap top, namely at least one of forming the entrapment element and another of bending the corners round under a plate in order to provide a securing member.

U.S. Pat. No. 6,112,452 discloses another kind of insect trap top that can be configured to contain one or two sets of threads to enable the invention to screw onto common household bottles with different opening diameters and different threading alignment and convert these bottles into an insect trap. An object of the invention is to provide an insect trap top that is easy to manufacture and to provide an insect trap top that can be mounted on different containers with different opening diameters, the containers having at least one protrusion such as a thread that may vary depending on the opening diameter.

In a first aspect of the invention these and other objects are achieved by an insect trap top wherein the at least one securing member is a number of spherical caps. It is an advantage to use at least one securing member that is formed as a number of spherical caps since it facilitates the manufacturing of the insect trap top because now the at least one securing member can be made in the same step as the rest of the insect trap top e.g. by moulding. Furthermore by using spherical caps it is possible to screw the insect trap top onto a container opening with a thread, which is advantageous for people with weak strength in their fingers. In addition the characteristics of a thread, such as diameter and pitch, are not critical, which provides that the insect trap top can be used for a range of different container openings, such as bottle necks. The insect trap top in U.S. Pat. No. 6,112,452 discloses an insect trap top with two different threads such that it can be mounted on two different containers with two different opening diameters, but still the disclosed insect trap top is sensitive to small variation in the characteristics of the thread. It is thus an advantage of the present insect trap top that it is less sensitive to small differences in the threads such that small variations in e.g. the bottle neck diameters as well as in the other thread characteristics, such as the pitch, because the fastening means comprises a flexible part with a securing means such that when pressed on the container the flexible part give way. The term “spherical caps” should be construed as any projection that has a partly spherical outer surface or an approximately partly spherical outer surface, or a semicircular outer surface.

The terms “entrapment element”, “fastening element” and “securing member” should be construed broadly, meaning that an element or a member may consist of several units or may be an assembly of units.

In an embodiment of the invention the at least one securing member further comprises one or more projections, lips, grooves, catches or any combination thereof. In an embodiment the at least one securing member does not comprise a thread.

In another embodiment the at least one fastening element comprises a skirt. The skirt may be circumferential to the at least one entrapment element. When the insect trap top is mounted with a container the skirt helps to position the at least one entrapment element in the container.

In yet another embodiment of the invention the at least one fastening element comprises at least two flaps. This provides for a more flexible fastening element. Preferably the flexible part of the at least one fastening element is the skirt of the at least two flaps, preferably three flaps, alternatively four flaps. The at least one securing member may be positioned on the skirt or the at least two flaps.

In a particular preferred embodiment of the invention the at least one fastening element is made in a material that is easy to mould such as a polymer in particular a thermoplastic polymer like Polypropylene PP, Polyethylen PE or Nylon. These are materials that are easy to manufacture and can be recycled.

In another embodiment of the invention the insect trap top is yellow or neon coloured or any other insect attracting colour.

In yet another embodiment the insect trap top is re-attachable to the container, which makes the insect trap top environmentally friendly.

In another embodiment of the invention the at least one entrapment element comprises a top section and a bottom section, the bottom section being narrower than the top section. This makes the insect trap top easier to stack and reduce the volume of the packing of a number of insect trap tops. Further more it makes it easier to trap the insect since the insects are guided through the at least one entrapment element into the container where they are trapped.

In another embodiment the at least one entrapment element is frusto-conical, funnel shaped or pyramid shaped. The at least one entrapment element may have an aperture at the bottom section that has a diameter that is between 6 mm-18 mm, such as between 8 mm-16 mm, particularly 10 mm-14 mm and preferably 12 mm. All these forms are easy to manufacture and can easily be stacked.

In a further embodiment the at least one entrapment element comprises a weakening line, preferably in form of a line of fracture. This enables the at least one entrapment element to be cut off or broken off or torn apart or in any other way detached, such that different lengths of the at least one entrapment element are provided. This is especially advantageous when the at least one entrapment element is frusto-conical, funnel shaped or pyramid shaped, as for these shapes not only the different lengths of the entrapment element are provided, but also different diameters of the aperture at the bottom section is provided. Because the diameter or the size of the aperture can be adjusted it is possible to adapt the insect trap top to insects of different sizes, in particular wasps and bees vary in size depending on the species.

In yet another embodiment the insect trap top comprises a plurality of openings, e.g. in form of perforations or slits. When the insect trap top is mounted on a container with a substance in the bottle the openings serve to the let aroma from the container escape and tempt the insects to come to the insect trap top. Preferably the openings are placed on the top section of the insect trap top. This makes it easier to manufacture. Alternatively the openings can be placed on the upper part of the insect trap or on the entrapment element e.g. as slits or in the bottle.

In a further embodiment of the invention the insect trap top further comprises a string. This facilitates that the insect trap top can be placed on branches.

In a particular preferred embodiment the total length of the fastening element is between 15-25% of the length of the insect trap top. When the insect trap top is mounted with the container the entrapment element may e.g. stick into the container between 50 mm-90 mm, such as between 60 mm-80 mm, preferably between 65 mm-75 mm. This makes it more difficult for possible liquid in the container to pour out and thus it is also prevented that insects too are poured out. In a second aspect of the invention an entrapment system for entrapment of insects is presented, the entrapment system comprising a container with at least one protrusion, an insect trap top comprising at least one fastening element for connecting the insect trap top with the container wherein the at least one fastening element comprises a flexible part with at least one securing member such that when pressed on the container the at least one securing member and the protrusion snap lock, and wherein the at least one securing member is a number of spherical caps.

In an embodiment of the entrapment system the container further comprises a substance comprising sugar. This tempts bees and wasps to come to the entrapment system. Other substances may be used e.g. ones comprising honey, jam, juice, fruit, yeast, water, meat or fish. The choice of substance may vary depending on the time of the year and the life cycle of the insect. Preferably part of the substance may be a liquid comprising washing up liquid such that the surface tension is reduced and the insects more easy are captured by the liquid in the container.

In another embodiment of the entrapment system the container comprises a plurality of openings e.g. in form of perforations or slits. This provides for aroma inside the container to escape through the openings out to the surroundings and temp the insects.

In yet another embodiment the entrapment system, the container is a bottle. This is an advantage due to the bottle neck, that makes it more difficult for a liquid to pour out.

In a further embodiment of the entrapment system the container comprises a thread. This makes it possible to use e.g. standard bottles used for e.g. fizzy drinks.

In yet another embodiment of the entrapment system the container is transparent or at least semi-transparent. This makes it difficult for wasps to escape from the container because the transparency confuses them.

In another embodiment the entrapment system further comprises a string for hanging the entrapment system. This string may e.g. be mounted through the insect trap top alternatively in the bottle.

The invention will now be explained in more detail below by means of examples of embodiments with reference to the schematic drawing. Like number refer to like features throughout the drawings.

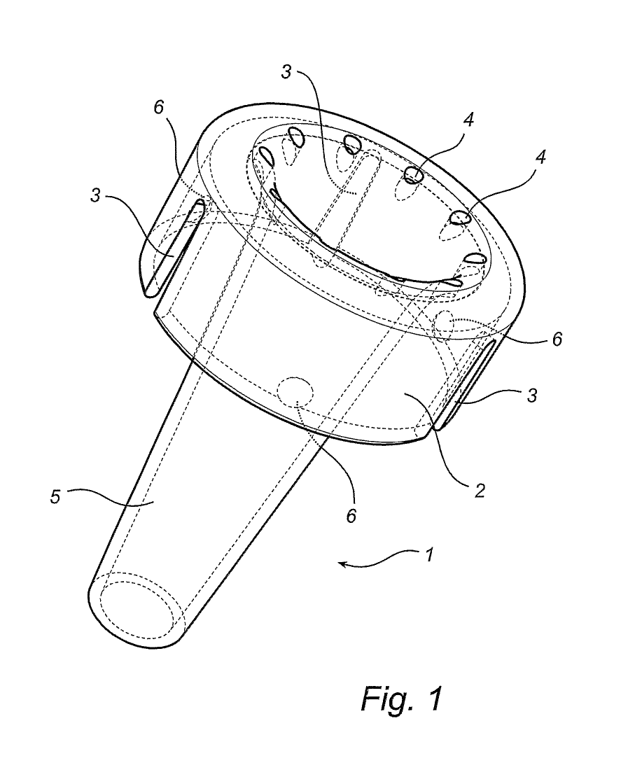

FIG. 1 is a perspective view of an embodiment of the insect trap top 1.

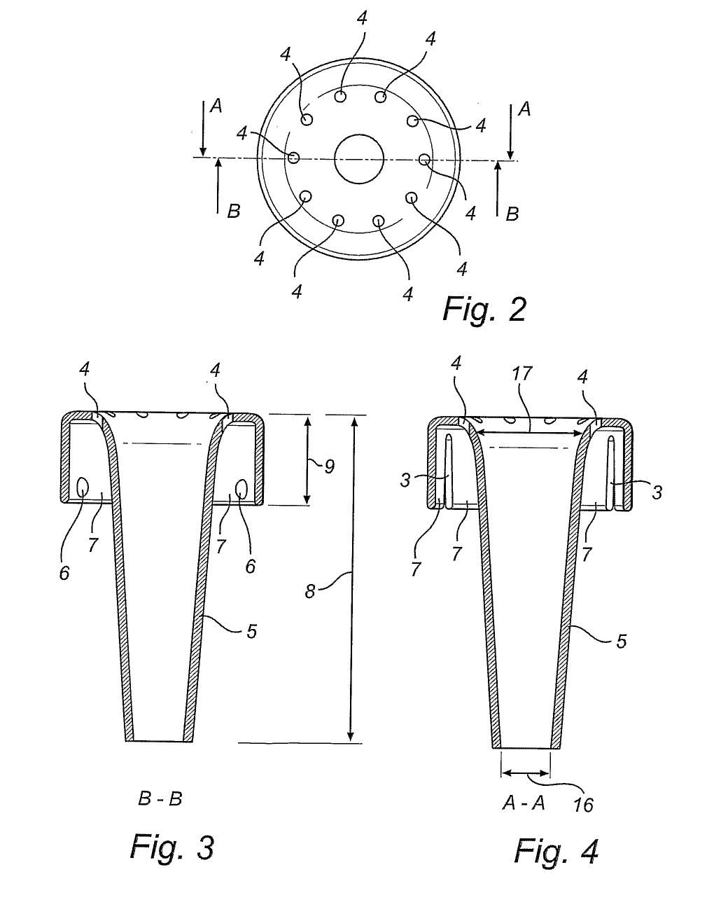

FIG. 2 is a top view of the insect trap top 1 shown in FIG. 1.

FIG. 3 is an axial cross section A-A of the insect trap top 1.

FIG. 4 is another axial cross section B-B of the insect trap top 1.

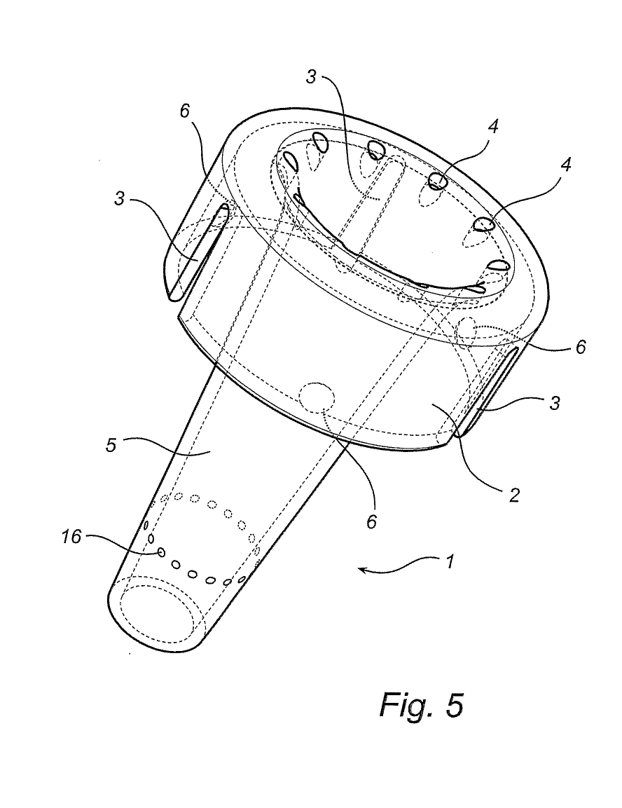

FIG. 5 is an insect trap top 1 with adjustable length of an entrapment element 5.

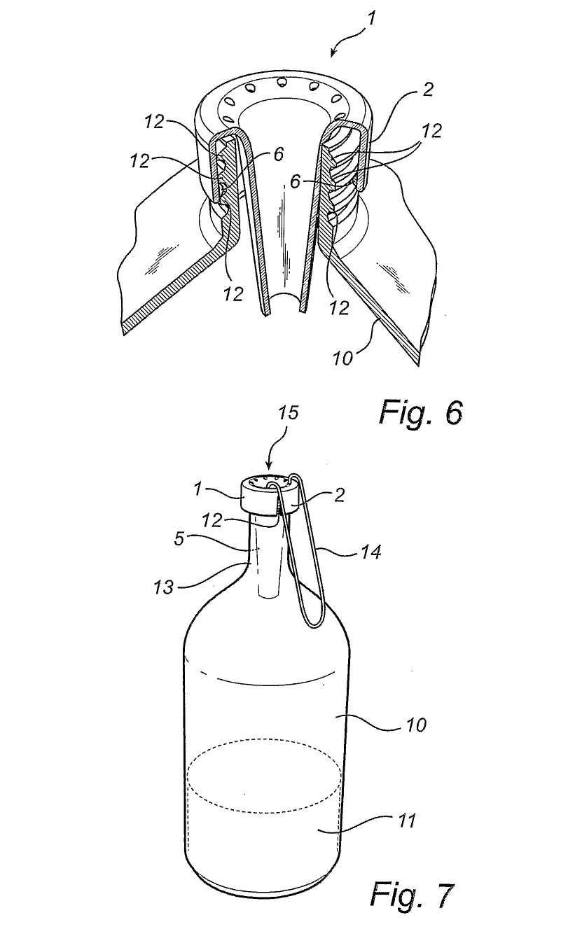

FIG. 6 is an axial cross section of the insect trap top 1 when mounted on a bottle 10.

FIG. 7 is a perspective view of an entrapment system 15.

FIG. 1 shows a perspective transparent view of an embodiment of the insect trap top 1. The insect trap top 1 has a fastening element in form of a skirt 2 with three recesses 3. The insect trap top 1 is made of a flexible material e.g., a flexible PP, PE or Nylon, such that a flexible part of the fastening element 2 is able to give way. A plurality of openings 4 are positioned in the upper part of the insect trap top 1. The fastening element is connected with an entrapment element 5 in form or an elongated, frusto-conical tube. The fastening element 2, in form of the skirt, circumference part of the entrapment element 5. The upper part of the insect trap top is curved such that the elongated tube 5 is joined with the skirt 2. The fastening element and the entrapment element are preferably in one piece of material, such that it is easier to manufacture.

FIG. 2 shows a top view of the insect trap top 1. From the top view the insects trap top has a circular shape with openings 4 positioned on a circle with the same centre as the insects trap top.

FIG. 3 and FIG. 4 show the axial cross section A-A and B-B of the insect trap top 1 shown in FIG. 2. The skirt 2 has a number of securing members in form of projections 6 positioned on the bottom part of the skirt 2. The projections 6, in form of spherical caps, are positioned on the inside of the securing member. Due to the three recesses 3 the skirt has three flaps 7 each with a projection 6. The length of the insect trap top 8 is 70 mm such that the elongated entrapment element passes the bottle neck when positioned in a bottle. The length of the fastening element 9 is 17 mm such that the ratio between the length of the fastening element 9 and the length of the insect trap top is between 20% and 30% preferably about 24%. The entrapment element, in form of a frusto-conical cylinder 5, comprises a circular top section and a circular bottom section, the bottom section being narrower than the top section. The smallest size of the bottom section is the aperture of the entrapment element, which has a diameter of 12 mm such that when the insect trap top is mounted on a container and a wasp is captured in a container, the wasp has difficulties escaping through the aperture of the entrapment element, and is trapped in the bottle. In other embodiments of the invention the size of the diameter of the aperture is between 6 mm and 18 mm. The size of the maximum diameter 17 of the frusto-conical tube in the top section is 21 mm. In other embodiments of the invention the maximum size of the frusto-conical tube is between 16 mm and 27 mm.

FIG. 5 shows an insect trap top 1 with adjustable length of the entrapment element 5. This is advantageous as the length of the entrapment element 5 can be changed. This is especially advantageous when the entrapment element is frusto-conical, funnel shaped or pyramid shaped, as for these shapes not only the different lengths of the entrapment element are provided, but also different diameters of the aperture at the bottom section is provided. Because the diameter or the size of the aperture can be adjusted it is possible to adapt the insect trap top to insects with different sizes, in particular wasps and bees vary in size depending on the species. In order to achieve this the entrapment element comprises a weakening line 16, in the illustrated example in form of a line of fracture 16. This enables that the entrapment element can be broken off, such that different lengths of the entrapment element are can be provided. The entrapment element may comprise a number of weakening lines thereby providing that a number of length of the entrapment element is provided. The weakening lines 16 can e.g. be made by perforations along the weakening line or alternative slits along the weakening line or a combination thereof. Alternatively the weakening line is marked on the entrapment means e.g. by a line such that it is indicated where the entrapment element should be cut off.

FIG. 6 shows the insect trap top 1 when mounted on a bottle 10. The insect trap top 1 is pressed over the bottle neck such that the securing member 6, e.g. in form of spherical caps, snap lock with the thread 12 of the bottle.

FIG. 7 shows a perspective view of an entrapment system 15 with an insect trap top 1 mounted on a bottle 10 with a thread 12. It is an advantage of the invention that the insect trap top can be mounted on a number of different bottles with different threads and bottleneck diameters. The bottle 10 may be semi-transparent preferably transparent such that when wasps are captured in the bottle 10, they find it difficult to orientate themselves and are trapped in the bottle 10. Part of the bottle 10 is filled with a liquid 11 with a substance comprising sugar, such as a beverage e.g. lemonade. Preferably the liquid 11 further comprises yeast so when wasps consume the liquid they get intoxicated by the liquid. Further more, the liquid can advantageously be added with some washing up liquid such that the surface tension is reduced and the insects are easier captured by the liquid in the container.

The insect trap top 1 is mounted with the bottle 10 by pressing the insect trap top 1 over the bottle neck 13, such that the frusto-conical tube 5 is inserted into the bottle 10 and the skirt 2 circumference the outside of the bottle neck 13. When the insect trap top 1 is pressed over the thread the flexible part of the fastening element give way and the securing member in form of the spherical caps glide over the thread such that the insect trap top 1 snap lock with the bottle 10. In this way an entrapment system for entrapment of insects 15 is made. Alternatively the insect trap top 1 can be screwed onto the bottle neck by letting the spherical caps glide along the thread of the bottle neck so that the thread and the spherical caps lock. This is an advantage for people with weak strength in the fingers. Liquid can be poured into the bottle 10 either before or after mounting of the insect trap top 1. One or more entrapment systems are placed on the ground around the wanted whereabouts. e.g. a table preferably a little in advance. Alternatively a string 14 is mounted through two of the openings 4 in the insect trap top 1 before it is mounted with the container 10 such that the entrapment system 15 can be hung on branches on threes and or bushes.

The insects are tempted by the aroma escaping from the bottle through the openings 4 and the frusto-conical tube 5. When the insects come to the entrapment system they are guided from the top section of the insect trap top 1 down into the bottle 10 trough the bottom section of the entrapment element 5 and are trapped into the bottle 10.

1-10. (canceled)

11. An insect trap top for mounting on a container with a protrusion, the insect trap top comprising
at least one insect entrapment element,
at least one fastening element comprising a flexible part with at least one securing member wherein the flexible part is adapted for giving way when pressed onto the protrusion of the container and the at least one securing member and the protrusion snap lock, and
wherein the at least one securing member is a number of spherical caps.

12. The insect trap top according to claim 11, wherein the at least one fastening element comprises a skirt.

13. The insect trap top according to claim 11, wherein the at least one fastening element comprises at least two flaps.

14. The insect trap top according claim 11, wherein the insect trap is made of a polymer selected from polypropylene (PP), polyethylene (PE) and nylon.

15. The insect trap top according to claim 11, wherein the at least one insect entrapment element comprises a top section and a bottom section, the bottom section being narrower than the top section.

16. The insect trap top according to claim 15, wherein the at least one insect entrapment element has an aperture at the bottom section that has a diameter between 6 mm-18 mm, preferably between 8 mm-16 mm, more preferably 10 mm-14 mm and most preferably 12 mm.

17. The insect trap top according to claim 11, wherein the at least one insect entrapment element is frusto-conical.

18. The insect trap top according to claim 11, wherein the at least one insect entrapment element comprises a weakening line.

19. The insect trap top according to claim 18, wherein the weakening line is a line of fracture.

20. The insect trap top according to claim 11, wherein the insect trap top comprises a plurality of openings.

21. The insect trap top according to claim 20, wherein the openings are placed on a top section of the insect trap top.

22. The insect trap top according to claim 11, wherein the insect trap top has an insect attracting colour, preferably yellow or neon coloured.

23. The insect trap top according to claim 11, wherein the total length of the fastening element is between 15-25% of the length of the insect trap top.

24. An insect entrapment system, comprising
a container with at least one protrusion,
an insect trap top comprising at least one fastening element comprising a flexible part with at least one securing member wherein the flexible part is adapted for giving way when pressed onto the container and the at least one securing member and the protrusion snap lock, and wherein the at least one securing member is a number of spherical caps.

25. The insect entrapment system according to claim 24, wherein the container comprises a thread.

26. The insect entrapment system according to claim 24, wherein the insect entrapment element projects into the container between 50 mm-90 mm, preferably between 60 mm-80 mm, and more preferably between 65 mm-75 mm.

27. The insect entrapment system according to claim 24, wherein the container is a bottle.

28. The insect entrapment system according to claim 24, wherein the container is transparent or at least semi-transparent.

29. The insect entrapment system according to claim 24, wherein the insect entrapment system further comprises a string.

30. An insect trap top for mounting on a container with a protrusion, the insect trap top comprising
at least one insect entrapment element,
at least one fastening element comprising a flexible part with at least one securing member wherein the flexible part is adapted for giving way when pressed onto the protrusion of the container and the at least one securing member and the protrusion snap lock, and
wherein the at least one securing member is a number of spherical caps, and the at least one insect entrapment element comprises a top section and a bottom section, the bottom section being narrower than the top section and the total length of the fastening element is between 15-25% of the length of the insect trap top.
